(19) United States
(12) Patent Application Publication
(10) Pub. No.: US 2023/0039394 A1
(43) Pub. Date: Feb. 9, 2023

(54) PORTABLE PRODUCTION MACHINE, MOBILE TERMINAL, PRODUCTION SYSTEM, AND METHOD FOR CAPTURING DATA

(71) Applicant: Illinois Tool Works Inc., Glenview, IL (US)

(72) Inventors: Oliver Oestrich, Mühlhausen-Ehingen (DE); Marcel Foh, Markdorf (DE)

(21) Appl. No.: 17/875,977

(22) Filed: Jul. 28, 2022

(30) Foreign Application Priority Data
Aug. 3, 2021 (DE) 102021120192.6
Jun. 22, 2022 (EP) 22180576.5

(51) Int. Cl. B23K 9/095; B23K 31/12; G06T 7/00; G06K 7/14

(52) U.S. Cl. CPC B23K 9/0953; B23K 9/0956; B23K 31/125; G06K 7/1417; G06T 7/0004; G06T 2200/24; G06T 2207/30152

(57) ABSTRACT

The present disclosure relates to a portable production machine, a mobile terminal, a production system having a portable production machine and a mobile terminal, and a method for capturing data. According to aspects of the disclosure, on the production machine - which can be, for example, a welding machine or cutting machine - production data is automatically captured, organized into data sets, and converted into data set images, which are displayed on a display device. The displayed data set images are captured with a mobile terminal and transmitted to a central server. As a result, a plurality of production machines can be incorporated into a data system without the need for any changes to the hardware in the production machines.

### RELATED APPLICATIONS

The present application claims the benefit of German (DE) Patent Application Serial No. DE 102021120192.6, filed Aug. 3, 2021, and to European (EP) Patent Application Serial No. 22180576.5, filed Jun. 22, 2022. The entireties of German (DE) Patent Application Serial No. DE 102021120192.6 and European (EP) Patent Application Serial No. 22180576.5are expressly incorporated herein by reference.

### FIELD OF THE DISCLOSURE

The present disclosure relates to a portable production machine, a mobile terminal, a production system having a portable production machine and a mobile terminal, and a method for capturing data.

### BACKGROUND

US 10,010,959 B2 and German utility model DE 20 2012 012 977 U1 disclose a supply of welding equipment power, which can be applied by scanning a barcode or another machine-readable coding. In a welding equipment power supply, a plurality of configurable parameters are to be calibrated in order to perform various welding operations. Industrial welding environments are generally unsuitable for operating conventional input apparatuses, such as a mouse, a keyboard, or other mechanically intensive components. By contrast to these apparatuses, barcode scanners are generally hermetically sealed and capable of withstanding adverse environmental conditions. The data scanned in this way can be displayed on a display device.

US 2017/0032281 A1 discloses a welding production expert system that is connected with a plurality of welding systems. The expert system can obtain and analyze data from individual welding systems. For this purpose, the individual welding systems are connected to the expert system via a data network. The welding systems can comprise different data interfaces (Bluetooth, ZigBee, Sonett, EtherCAT, PROFINET, Profibus, DeviceNet, Modbus, P2P, or an interface to another standardized network). Capturing data from a plurality of different welding systems is very advantageous, because the larger the database, the better the analysis of the expert system.

Portable welding apparatuses are used in a variety of situations and locations. Internet is generally not available at worksites. It is therefore difficult to connect the individual welding apparatuses to a server, in particular a server of an expert system, using a data line.

### SUMMARY

The disclosure therefore addresses the problem of creating a portable production machine, in particular a welding machine, a mobile terminal, a production system, and a method for capturing data, with which production data, in particular welding data, can be captured and transmitted to a server in a simple manner.

A further problem of the present disclosure is to create a method that can be easily retrofitted in existing portable production machines.

One or more of the aforementioned problems are solved by the subject-matters of the independent claims. Advantageous embodiments are specified in the subclaims.

According to a first aspect of the present disclosure, there is provided a portable production machine, in particular a welding machine,
with one or more sensors for monitoring a production process,
a display device suitable for displaying a two-dimensional graphical display, and
a control device configured so as to monitor the production process, wherein the one or more sensors are used in order to capture data describing the production process.

The production machine is characterized in that the control device is configured so as to summarize the captured data into a data set and convert the data set into a machine-readable data set image and display the data set image on the display device.

Such a machine-readable data set image can be captured by means of a camera, in particular a mobile terminal comprising a camera, and transmitted to a server via a data link.

As a result, production data of the portable production machine can also be reliably captured at remote locations where no data network and in particular no internet, is available. For example, the data in question can be temporarily stored on the mobile terminal and, if the mobile terminal is moved to a location where a data network is present, the data can then be transmitted to the corresponding server.

The control device can be configured so as to convert the data set into a plurality of data set images, into which the data of the respective data set is distributed and can be displayed simultaneously and/or sequentially on the display device.

By distributing a data set into a plurality of data set images, data sets with an amount of data that exceeds the capacity of a data set image can also be transmitted.

The production machine is preferably configured such that an allocation code is respectively generated for the plurality of data set images and displayed simultaneously with the respective data set image on the display device, such that the plurality of data set images can be allocated to one another in a predetermined order. This allocation code can be integrated into the individual data set images or displayed independently from the data set images on the display device. The allocation code ensures that multiple data set images containing the data of a data set are correctly combined so that the data contained in multiple data set images can be reliably compiled into the respective data set.

The data set image(s) are preferably represented with a machine-readable coding of data, particularly a two-dimensional coding, such as a QR code or barcode. As a result, larger amounts of data can be reliably represented in a data set image that is suitable for display on a display device and can be read by means of a machine reading device. Preferably, the machine-readable coding is standardized so that commercially available computers can be used in order to generate the coding, scan and read the coding, and extract the data contained therein.

Machine readable coding can also include OCR fonts. However, it is expedient when the data is arranged in a predetermined format so that the arrangement of the data is taken into account when extracting and interpreting the data. For example, data identifying the machine being used, such as the machine name, its serial number, etc. at a particular region in the data set image, and measurement data such as a welding current, welding speed, etc. can be arranged in a different region of the data set image. This can significantly simplify extraction of the data from the optically scanned data set image.

The data set images are thus specially prepared in order to be able to reliably and easily scan them visually and extract the data contained therein.

The production machine, which is preferably a welding machine, comprises one or more of the following sensors for monitoring the production process or the welding/cutting process:
Temperature sensor
Inertial sensor
Position sensor
Optical sensor
Gas sensor, in particular oxygen sensor
Ammeter and/or voltmeter
Wire feeder sensor.

Pre-determined data captured with the sensors is summarized into a data set, which can then be converted into one or more data set images.

With one or more temperature sensors, different temperatures can be captured during the production process. For example, if the production process is a welding process, the temperature of a predetermined spot on the welding head can be captured. The temperature describes the thermal load on the welding head.

With an inertial sensor, the movement of a particular part of the production machine can be captured. In a cutting or welding machine, where a cutting or welding head is moved manually or automatically, the movement of that head can be captured and recorded with the inertial sensor.

There are welding heads, in particular in orbital welding apparatuses, in which a welding electrode is moved automatically. The position of the welding electrode relative to the remaining welding head can be captured and recorded by means of a position sensor.

The production process can be monitored with an optical sensor. Typically, a camera is used as an optical sensor. However, non-imaging optical sensors can also be used. An optical sensor can be used in order to visualize the product to be processed or the tool with which the product is processed. However, an optical sensor can also be used for spectral analysis. Here, it is expedient when the optical sensor is configured as a color sensor that is capable of capturing light at different wavelengths.

Further, a gas sensor can be provided, which detects the presence of a particular gas. This gas sensor can be configured as a chemo sensor for detecting certain gaseous substances on the one hand, or as a flow sensor for measuring the flow of gas supplied from a particular gas source on the other hand.

The sensor can be configured as an ammeter and/or voltmeter. This is convenient for electrical welding devices, in particular, in order to measure the applied welding current.

In a welding machine, a wire feeder sensor can also be provided, with which the rate at which a welding wire is supplied to a welding location is measured.

Depending on the type of production process to be monitored, the type and number of sensors can vary.

In addition to the data captured with the sensors, the data set generally comprises further data, for example an identification number of the production machine, in the case of a welding apparatus the wire thickness of a wire used or the material from which the wire is formed or other parameters that are known or can be determined on the production machine, such as parameters derived from the sensor values or other values.

According to a further aspect of the present disclosure, a mobile terminal is provided, comprising a camera, wherein the mobile terminal is configured so as to capture one or more data set images displayed on a display device, and wherein the mobile terminal comprises an interface to a data network, and wherein the mobile terminal is configured such that the data set image(s) and/or data contained in the data set images can be transmitted via a data network to a server.

The mobile terminal can thus be used in order to capture and transmit the data set images displayed on the display device of the production machine to a server via the data network. The mobile terminal is preferably a mobile phone. However, the mobile terminal can also be another device comprising a camera, a microprocessor, and an interface to a data network. The interface to a data network can be a cellular interface pursuant to a cellular standard (e.g., 2G, 3G, 4G, and/or 5G). However, the interface to the data network can also be an interface to a WLAN or wired data network. Preferably, the mobile terminal is a commercially available mobile phone containing a computer program product (= app) configured so as to capture the one or more data set images displayed on a display device and forward them to the server.

The mobile terminal is preferably configured so as to scan data set images prepared in a predetermined manner such that the extraction of the data can be easily carried out.

According to a further aspect of the present disclosure, the mobile terminal can be configured so as to capture data displayed on the display device of the production machine and forward it to a server. The data does not need to be specially prepared on the production machine for this purpose. The mobile terminal is configured so as to capture the conventionally displayed images on the display device containing the data and to extract the data therefrom. This is more costly than capturing specially prepared data set images, however it allows the data to be captured automatically without the need for any changes to the production machine. In such an embodiment, the captured images are typically subjected to an OCR process, and the raw data obtained therefrom is prepared. This preparation can be carried out by means of one or more filters. This OCR process and the processing of the data can be carried out on the mobile terminal and/or the server.

The mobile terminal is preferably configured such that a plurality of data set images containing data from a common data set is stored on the mobile terminal while being allocated to one another and/or transmitted via the data network and/or data of a data set is extracted on the mobile terminal from one or more data set images and stored on the mobile terminal and/or transmitted via the data network.

When the mobile terminal is configured such that the data set images and/or the data contained therein can be kept in extracted form as data sets, then the data set images can be captured with the mobile terminal on the production machine or welding machine. When the production machine is located in a place where there is no access to the data network, the data set images or the data contained therein can be kept on the mobile terminal until the mobile terminal can be brought back to a location where there is access to the data network. As a result, even in remote regions, the production machines can be operated, and the corresponding data can be reliably captured and transmitted to the server at a time delay. If the production machine is located in a place where the mobile terminal has access to a data network, then the data set images and/or data therein that has been extracted from the data set images can be transmitted to the server by the display device of the production machine via the data network immediately upon capture.

The mobile terminal is preferably configured so as to automatically capture a sequence of data set images. For this purpose, the mobile terminal can be configured so as to independently detect when a data set image changes on the display device, so that it captures, caches, and/or extracts the data therein and/or routes it to the server directly via the data network. Here, the individual data set images with individual "still images" can be captured by the mobile terminal. However, it is also possible for the mobile terminal to record sequentially displayed data set images with a film sequence, which is then analyzed on the mobile terminal and/or the server such that the individual data set images are extracted.

The sequence of the data set images or the data is preferably carried out on the display device at a display frequency of at least 1 Hz, more preferably at least 16 Hz (fast enough so that it is not recognizable to the naked human eye) and more preferably at a frequency close to or equal to a camera image frequency of a mobile terminal, e.g., 24-60 Hz or even 60 Hz to 240 Hz (slow-motion mode).

The mobile terminal can also be configured so as to automatically allocate a plurality of data set images to a data set. This can be done, for example, by detecting the allocation code allocated to the respective data set images, such that one of a plurality of data set images is selected, respectively, that contain data of a data set and are also arranged with respect to one another in such a way that the data in the data set is correctly arranged. Thus, it is possible to transmit multiple data sets in succession by means of a plurality of data set images.

When the mobile terminal is configured so as to extract the data of a data set from one or more data set images, then further data captured at the mobile terminal can also be added to the respective data set.

For this purpose, the mobile terminal can comprise one or more further sensors in order to capture predetermined data. This data can be for example, geo-data that is associated with a corresponding geo-sensor (e.g., GPS), image data captured with a camera, or data manually entered by the user. For example, the mobile terminal can be configured in order to ask the user for certain information, which he or she can then manually enter. The data thus either automatically and/or manually captured is then added to the respective data set before it is transmitted to the server. The data can include an identification (ID) of the user or welder that is [detected] manually or by means of a sensor for scanning a bar code/QR code, the face of the user/welder, a fingerprint or an iris, or another piece of biometric information.

The data captured on the mobile terminal can also be allocated to, and transmitted to, the server along with certain data set images. The server then extracts the data from the data set images and integrates the further data captured on the mobile terminal into the respective data set.

According to a further aspect of the present disclosure, there is provided a production system comprising a production machine, in particular a welding machine or cutting machine, as explained above and having a mobile terminal configured as explained above. With this production system, a production process can be monitored, and the data generated can be transmitted to a server via the mobile terminal.

Aspects of this disclosure can be retrofitted on existing production machines comprising a display device that is suitable for displaying the data set images, wherein only the software must be changed, and no hardware needs to be retrofitted. With the use of a mobile terminal, in particular a commercially available mobile phone, it is possible to transmit the data generated on the production machine to a server. The production machine can be used at any location. It is not necessary for a data network to be present at the respective location. With the mobile terminal, the data can be captured, and then the mobile terminal can be brought to a location where connection to a data network is possible in order to transmit the data to the server. The data set images or the data extracted therefrom can be temporarily stored on the mobile terminal until it can be transmitted to the server.

According to a further aspect of the present disclosure, there is provided a method for capturing data describing a production process, said method being carried out with a portable production machine, in particular a welding machine, wherein the production process is monitored with sensors, wherein the data describing the production process is generated, wherein the data for a particular production process or a particular portion of a production process respectively forms a data set, and the data of a data set is converted into one or more machine-readable data set images, and the data set image(s) are displayed on the display device and captured by a mobile terminal that scans the display device and are then transmitted from the mobile terminal to a server via a data network.

With this method, production data associated with a production process of a portable production machine can be easily captured and transmitted to a server. The server can capture and evaluate the data and make it accessible for further processing from a plurality of different production machines. The server can be part of an expert system. The server can also be a cloud server on which the data is merely cached and/or processed. An expert system can be integrated into such a cloud server, for example.

The production machine used in this case can correspond to the production machine discussed above. The mobile terminal used in this case can correspond to the mobile terminal described above.

### BRIEF DESCRIPTION OF THE DRAWINGS

Aspects of this disclosure are explained in further detail below with reference to the drawings. The drawings schematically show the following:

FIG. 1a welding system and a mobile terminal for transmitting the data of the welding system to a server,

FIG. 2a method for capturing data of a welding process carried out on the welding system in a flow chart,

FIG. 3a data set for a particular welding operation, and

FIG. 4a further data set for a further welding operation.

### DETAILED DESCRIPTION

Aspects of this disclosure are explained in further detail below on the basis of a production machine, which is a welding machine 1. The welding machine 1 comprises a base station 2 and a welding head 3, which is connected to the base station 2 by a cable 11. In the present exemplary embodiment, the welding head 3 is configured as an orbital welding head, i.e., a welding head that can be used for connecting two pipe ends by means of a weld connection. Such welding machines are known, for example, from US 2010/0051586 A1 and EP 3 650 157 A1. They can have one or more sensors in the region of the base station 2 as well as in the region of the welding head 3. The base station 2, which is also referred to as the welding power source, serves to supply the welding head 3 with welding power. For this purpose, the base station 2 comprises an ammeter for measuring the welding current. An oxygen sensor for measuring the oxygen content within a welding chamber, a temperature sensor, and/or an inertial sensor can be provided on the welding head 3.

The base station 2 comprises a display device 4. The display device is preferably a color screen with a resolution of at least 200 x 150 pixels, in particular 400 x 300 pixels in a 4:3 aspect ratio format. However, higher resolution screens such as 800 x 600 pixels or 1260 x 1440 pixels and/or with another aspect ratio such as 16:9 or 21:9 can also be provided. The display device is thus a two-dimensional display device, which is suitable for the displaying two-dimensional images or graphical representations.

The base station 2 comprises a central control device, which controls all functions of the base station 2. With the central control device, individual functions of the welding head 3 can also be controlled.

The base station 2 comprises a memory device (not shown), in which executable program code and other data can be stored.

During a welding operation, various data is captured with the sensors and stored in the base station 2 and/or in the welding head 3. A welding operation can thus be monitored with the base station 2.

This welding machine 1 is a portable welding machine, i.e., it can be used at different locations for the welding of pipes. The display device 4 can be arranged on the inside of a lid 5 of the base station 2, for example. The lid 5 can be folded during transport of the welding machine 1, so that the display device 4 is protected.

The welding machine 1 is part of a welding system that comprises a mobile terminal 6 and a server 7 in addition to the welding machine 1. The mobile terminal and the server 7 can be connected to one another via a data network 8. The data network 8 is typically the internet. However, a different WAN or LAN can also be used. The mobile terminal 6 can also be connected directly to the server 7 by means of a data interface.

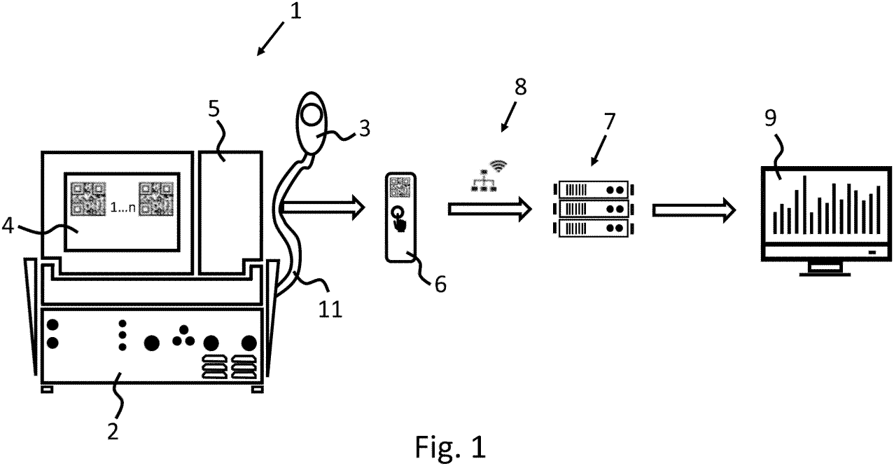

In the present exemplary embodiment, a data analysis system is configured on the server 7, which, in the present case, is an expert system 9 that regularly receives data from a plurality of welding machines 1, as will be explained in further detail below. The expert system 9 analyzes the data and automatically generates suggestions, control instructions, and conclusions that are provided to the users of welding machines 1 during future welding operations. The output of the expert system is symbolically represented in FIG. 1 by a display screen 9. The output can be via a variety of data channels. For example, users of mobile terminals 6 can obtain corresponding evaluation results from the expert system.

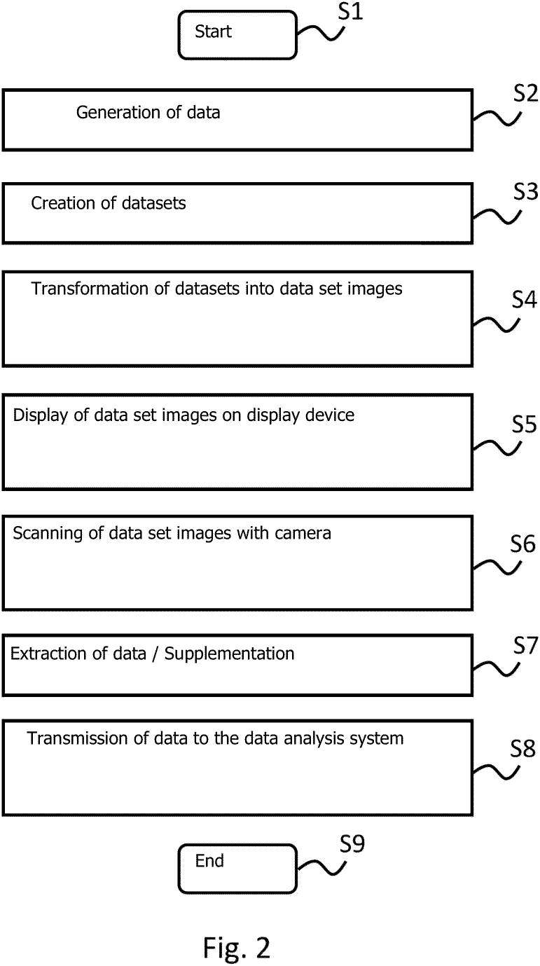

Below, the method is explained using the flow chart shown in FIG. 2, starting with the generation of data from the production process and ending with the transmission of the data to the server 7 or the data analysis system configured therein.

The method starts with step S1.

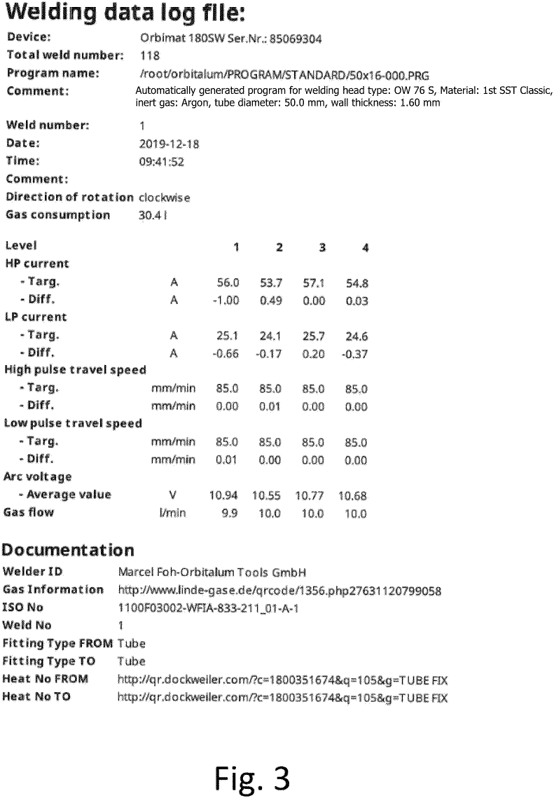

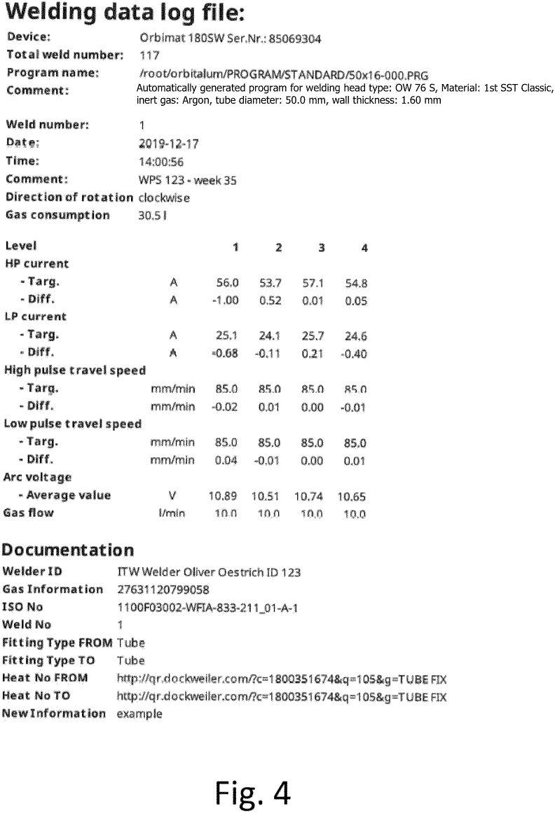

In step S2, when the production process is executed, data is generated that is captured using the aforementioned sensors of base station 2 and/or welding head 3 and stored in base station 2 and/or welding head 3. A data set for each welding operation is created in the base station 2, for example as shown in FIG. 3 and FIG. 4. This data set is also referred to as a log file. The data set contains information about the welding machine used, the timing, and the production parameters, which constitute welding parameters in the present embodiment. In the present exemplary embodiment, the welding parameters include current values of a current supplied in pulses for HP (high pulse) and LP (low pulse), the velocity of movement of the electrode, the welding voltage, and the gas flow of the inert gas.

The data sets contain further data relating to the person performing the welding operation, welding gas information, and parameters relating to particular components of the welding machine 1.

The data sets are created in the base station 2 (step S3).

The individual data sets are each transformed into one or more data set images (step S4). In the present embodiment, a standardized QR code is used as a data set image. However, in the context of this disclosure, other coding types are possible as data set images, in particular in the form of two-dimensional graphical representations.

Generally, it is also possible to convert the data set into data set images representing the data in an OCR-enabled font, wherein each data set image contains a specific amount of data or values. However, a coding of the data set in a two-dimensional graphical representation, such as in a QR code, is preferred, because much information can be compressed on a small surface, and it can be reliably scanned.

For larger data sets, it is expedient to distribute the data of a data set among multiple data set images and generate an allocation code for each data set image. The allocation code can be incorporated into the respective data set image.

The data set images 10 are displayed on the display device 4 of the base station 2 (step S5).

If a single data set image 10 contains a complete data set, then the data set image 10 can be scanned with the mobile terminal 6 having a camera (step S6).

If a data set is distributed among multiple data set images 10, then the multiple data set images 10 can either be displayed side-by-side on the display device 4, when sufficiently large, or the individual data set images 10 belonging to a data set are shown in succession on the display device 4. The plurality of data set images 10 associated with a data set are preferably shown along with the respective allocation code on the display device 4. The allocation code can be part of the data set images 10 or can be displayed on the display device 4 in addition to the data set images 10. The allocation code is also read with the mobile terminal 6, and, based on the allocation code, multiple data set images 10 are allocated to a specific data set.

The mobile terminal 6 comprises a memory device in which the plurality of data set images 10 can be stored.

In a preferred embodiment, the data set images are already extracted in the mobile terminal 6 (step S7) in order to restore the data sets of the welding machine 1 to their original form. Further information can be added to the data sets present at the mobile terminal 6. This further information can be supplemented with sensors provided at the mobile terminal 6 (camera, location sensor, etc.) or by data manually inputted by the user (step S7).

The data sets prepared in this way are then transmitted from the mobile terminal 6 to the server 7 via the data network 8 (step S8). This transmission of data can also be carried out at a time delay for capturing the data by means of the mobile terminal 6 at the base station 2. This is expedient especially when the welding machine 1 is in a location where there is no access to the data network 8. The data set images or data sets of several welding operations can be cached in the mobile terminal 6 and transmitted from the mobile terminal 6 to the server at a later point in time when the mobile terminal 6 is located in a place where there is access to the data network 8.

On the server 7, the data of the welding machine 1 is evaluated and incorporated into the expert system, which is available to the users of the respective welding machine 1 for further welding operations.

Step S9 ends this method.

In the exemplary embodiment discussed above, the data sets are extracted from the data set images 10 at the mobile terminal. In the context of this disclosure, it is also possible to transmit the data set images substantially unchanged from the mobile terminal 6 to the server 7 and to extract them there. Steps S7 and S8 are then switched. Additional data can also be added to the data set images 10 transmitted from the mobile terminal 6 to the server 7, which is then inputted into the corresponding data sets on the server 7.

The disclosure has been explained above by way of an exemplary embodiment of a production machine that is a welding machine. In the context of this disclosure, the production machine can also be another portable production machine, such as a cutting machine or the like. To carry out aspects of the present disclosure, the portable production machine should comprise a display device, a central control device, and one or more sensors for capturing production data. Then, the method discussed above can be similarly carried out on this production machine.

In accordance with this disclosure, it is possible that, on portable production machines such as portable welding machines, data of the production process can be captured and transmitted to a central server 7 without the need for the respective production machines themselves to be connected to a data network. By graphically preparing the data sets and scanning the data set images with the mobile terminal, the data from the production machine can be easily transmitted to the central server 7 via a data network. Aspects of this disclosure can be retrofitted simply to existing production machines having a display device. Only the software of the production machine needs to be changed here. No hardware measures are necessary. It is thus possible to capture, centrally compile, and centrally evaluate production data from a variety of similar production machines and automatically generate corresponding conclusions, instructions, and the like. One only needs a suitable software on the production machine for displaying the data on the display device and a suitable software (=app) on the mobile terminal for inputting and forwarding the data to the server.

The transmission between the mobile terminal 6 and the server 7 is preferably encrypted.

When the data sets are to be divided into a plurality of data set images 10, the software on the mobile terminal 6 is preferably configured such that the plurality of data set images 10 are automatically input successively and allocated correctly and in the proper order to the respective data sets.

Aspects of this disclosure make it possible to read out existing production machines used in remote locations in large numbers and integrate them into a common data system. This can significantly increase the quality of the production process.

The disclosure can be briefly summarized as follows:

The present disclosure relates to a portable production machine, a mobile terminal, a production system having a portable production machine and a mobile terminal, and a method for capturing data. In the disclosure, on the production machine - which can be, for example, a welding machine or cutting machine - production data is automatically captured, organized into data sets, and converted into data set images, which are displayed on a display device. The displayed data set images are captured with a mobile terminal and transmitted to a central server. As a result, a plurality of production machines can be incorporated into a data system without the need for any changes to the hardware in the production machines.

### List of Reference Numerals

1 Welding machine
2 Base station
3 Welding head
4 Display device
5 Lid
6 Mobile terminal
7 Server
8 Data network
9 Screen
10 Data set image
11 Cable

What is claimed is:

1. A portable production machine, comprising:
one or more sensors for monitoring a production process,
a display device, which is suitable for displaying a two-dimensional graphical display, and
a control device, which is configured so as to monitor the production process, wherein data describing the production process is captured with the one or more sensors,
wherein the control device is configured so as to summarize the captured data into a data set and convert the data set into a machine-readable data set image and display the data set image on the display device.

2. The production machine according to claim 1, wherein the control device is configured so as to convert the data set into a plurality of data set images, into which the data of the data set is distributed, and which are displayed simultaneously and/or sequentially on the display device.

3. The production machine according to claim 2, wherein an allocation code is respectively generated for the plurality of data set images and displayed simultaneously with the respective data set image on the display device, such that the plurality of data set images can be allocated to one another in a predetermined order.

4. The production machine according to claim 1, wherein the data set image is a machine-readable coding of data, in particular a two-dimensional coding, such as a QR code.

5. The production machine according to claim 1, wherein the production machine comprises one or more of the following sensors for monitoring the production process:
a temperature sensor,
an inertial sensor,
a position sensor,
an optical sensor,
a gas sensor,
an ammeter,
a voltmeter, or
a wire feeder sensor.

6. A mobile terminal comprising a camera, wherein the mobile terminal is configured so as to capture one or more data set images displayed on a display device, and wherein the mobile terminal comprises an interface to a data network, and wherein the mobile terminal is configured such that the data set images or data contained in the data set images can be transmitted via a data network to a server.

7. The mobile terminal according to claim 6, wherein the mobile terminal is configured such that a plurality of data set images containing data from a common data set is stored on the mobile terminal while being allocated to one another or transmitted via the data network or data of a data set is extracted on the mobile terminal from one or more data set images and stored on the mobile terminal and/or transmitted via the data network.

8. The mobile terminal according to claim 6, wherein the mobile terminal is configured so to automatically capture a sequence of data set images, or the mobile terminal is configured so as to automatically allocate multiple data set images to a data set.

9. A production system, comprising:
a portable production machine according to claim 1;
a mobile terminal, comprising a camera, wherein the mobile terminal is configured so as to capture one or more data set images displayed on a display device, and wherein the mobile terminal comprises an interface to a data network, and wherein the mobile terminal is configured such that the data set images or data contained in the data set images can be transmitted via a data network to a server; and
the server, wherein the mobile terminal can be connected to the server via a data network in order to transmit the data set images or data contained in the data set images to the server.

10. A method for capturing data describing a production process, said method being carried out with a portable production machine, wherein the production process is monitored with sensors, wherein the data describing the production process is generated, wherein
the data for a particular production process or a particular portion of a production process respectively forms a data set, and the data of a data set is converted into one or more machine-readable data set images, and the data set image(s) are displayed on the display device and captured by a mobile terminal that scans the display device and are then transmitted from the mobile terminal to a server via a data network, wherein
the method involves using at least one of:
a portable production machine, comprising:
one or more sensors for monitoring a production process,
a display device, which is suitable for displaying a two-dimensional graphical display, and
a control device, which is configured so as to monitor the production process, wherein data describing the production process is captured with the one or more sensors,
wherein the control device is configured so as to summarize the captured data into a data set and convert the data set into a machine-readable data set image and display the data set image on the display device; or
a mobile terminal comprising a camera, wherein the mobile terminal is configured so as to capture one or more data set images displayed on a display device, and wherein the mobile terminal comprises an interface to a data network, and wherein the mobile terminal is configured such that the data set images or data contained in the data set images can be transmitted via a data network to a server.
